(19) United States
(12) Patent Application Publication
(10) Pub. No.: US 2026/0175764 A1
(43) Pub. Date: Jun. 25, 2026

(54) RAMP SYSTEM AND VEHICLE INCLUDING SAME

(71) Applicants: Hyundai Motor Company, Seoul (KR); Kia Corporation, Seoul (KR)

(72) Inventors: Kyeong Ho Kim, Hwaseong-si (KR); Hyuk Ho Kwon, Hwaseong-si (KR); Hyun Woo Jin, Hwaseong-si (KR)

(21) Appl. No.: 19/084,332

(22) Filed: Mar. 19, 2025

(30) Foreign Application Priority Data
Dec. 23, 2024 (KR) 10-2024-0193978

(51) Int. Cl. B60P 1/43; A61G 3/06; B60J 5/06; B60R 3/02

(52) U.S. Cl. CPC B60P 1/435; B60J 5/06; B60R 3/02; A61G 3/061

(57) ABSTRACT

A ramp system can include a frame and a ramp plate configured to move along a length direction of the frame, where the ramp plate can include a base plate configured to rotate with the frame as a rotation axis. A vehicle can include the ramp system, a vehicle body, and a door. The vehicle body can have an opening. The door can be disposed on the vehicle body and can open and close the opening of the vehicle body. The ramp plate can be disposed in an internal space of the door. The frame can be coupled to the door and configured to allow the ramp plate to slide relative to the door.

### CROSS-REFERENCE TO RELATED APPLICATIONS

This application claims benefit of priority to Korean Patent Application No. 10-2024-0193978 filed on Dec. 23, 2024 in the Korean Intellectual Property Office, the disclosure of which is incorporated herein by reference in its entirety.

### TECHNICAL FIELD

The present disclosure relates to a ramp system provided for boarding and alighting of transportation-disadvantaged passengers.

### BACKGROUND

A ramp may be provided as a way of assisting boarding or alighting of transportation-disadvantaged passengers. A ramp may form a slope structure connecting the interior and exterior of a vehicle to move wheelchairs, or the like, into the vehicle. A ramp may form a slope by being installed on a vehicle and unfolded. When one side of the ramp arranged toward a vehicle body is excessively high, the slope of the ramp may become steep. When the slope becomes steep, it may be difficult for wheelchairs to move on the ramp, and further, the wheelchair may fall off the ramp. Particularly, in the case of an electric vehicle, the floor surface of the vehicle body may become higher due to a battery installed at the bottom of the vehicle body, and accordingly, the slope angle of the ramp may also become greater, which may be problematic.

### SUMMARY

An embodiment of the present disclosure can provide a ramp system in which a slope angle of a ramp may be reduced to facilitate boarding of transportation-disadvantaged passengers.

According to an embodiment of the present disclosure, a ramp system can include: a frame; and a ramp plate configured to move along a length direction of the frame, wherein the ramp plate includes a base plate configured to rotate with the frame as a rotation axis.

A ramp system may further include a sliding plate disposed to face one surface of the base plate and configured to move along one surface of the base plate.

A ramp system may further include: a screw disposed on one side of the base plate; and a screw bracket coupled to one side of the sliding plate, coupled to the screw, configured to move along the length direction of the screw.

A ramp system may further include a driving portion disposed on one end of the screw and configured to rotate the screw. The other end of the screw may be disposed in the frame.

The frame may include: a fixed frame configured to be coupled to a vehicle door; and a moving frame disposed on an outer side of the fixed frame and sliding along the fixed frame, and wherein the base plate is coupled to the moving frame.

A ramp system may further include a fixed bracket coupled to the fixed frame and configured to connect the fixed frame to a door.

The fixed bracket may include: a first fixed bracket disposed on one side of the fixed frame; and a second fixed bracket spaced apart from the first fixed bracket in the length direction of the fixed frame.

The moving frame may include a guide groove formed in the length direction of the moving frame, and the guide groove overlaps the first fixed bracket in the length direction of the moving frame.

A ramp bracket may be disposed on an outer circumferential surface of the moving frame, and the ramp bracket may be coupled to the ramp.

The ramp bracket may be configured to rotate along an outer circumferential surface of the moving frame.

The moving frame may include a support portion supporting load of the ramp plate.

The support portion may include: a housing; a spring disposed on an internal side of the housing; and a support stand having at least a portion protruding from an outer side of the housing.

According to an embodiment of the present disclosure, a vehicle can include: a vehicle body; a door disposed in the vehicle body and opening and closing an opening of the vehicle body; a ramp plate disposed in an internal space of the door; and a frame coupled to the door and configured to allow the ramp plate to slide, wherein the ramp plate includes a base plate configured to rotate with the frame as a rotation axis; and a sliding plate disposed to face one surface of the base plate and configured to slide along one surface of the base plate.

A vehicle may further include: a side step disposed in a lower portion of the vehicle body; and a support portion coupled to the frame, wherein the side step supports the support portion on a lower side of the support portion.

The support portion may include: a housing; a support stand having at least a portion protruding from an outer side of the housing; and a spring disposed on an internal side of the housing and supporting the support stand, wherein the support stand is in contact with the side step.

### BRIEF DESCRIPTION OF THE DRAWINGS

The above and other features and advantages of example embodiments of the present disclosure will be more clearly understood from the following detailed description, taken in conjunction with the accompanying drawings, in which:

FIG. 1 is a diagram illustrating a usage state in which a ramp is unfolded according to an embodiment of the present disclosure;

FIG. 2 is a diagram illustrating a state in which a ramp is inserted into a door of a vehicle body according to an embodiment of the present disclosure;

FIG. 3 is a diagram illustrating a state in which a ramp is withdrawn from a door of a vehicle body according to an embodiment of the present disclosure;

FIG. 4 is a diagram illustrating the state in FIG. 3 taken along line A-A′ in FIG. 3;

FIG. 5 is a diagram illustrating the state in FIG. 1 taken along line A-A′ in FIG. 1;

FIG. 6 is a perspective diagram illustrating a ramp assembly according to an embodiment of the present disclosure;

FIG. 7 is an exploded diagram illustrating a ramp assembly according to an embodiment of the present disclosure;

FIG. 8 is a perspective diagram illustrating a portion of a ramp assembly according to an embodiment of the present disclosure; and

FIG. 9 is a cross-sectional diagram taken along line I-I′ in FIG. 8.

### DETAILED DESCRIPTION OF ILLUSTRATIVE EMBODIMENTS

Hereinafter, example embodiments of the present disclosure will be described with reference to the attached drawings.

Various example embodiments will be described with reference to accompanying drawings. However, this may not necessarily limit the scope of other embodiments to a specific embodiment form. Instead, modifications, equivalents, and replacements included in the disclosed concepts and technical scopes of this description may be employed. Throughout the specification, similar reference numerals can be used for similar elements.

The terms “first,” “second,” and the like may be used to distinguish one element from another, and may not necessarily limit a sequence and/or an importance, or others, in relation to the elements. In some cases, a first element may be referred to as a second element, and similarly, a second element may be referred to as a first element without departing from the scopes of rights of the embodiments.

An expression used in the singular can encompass the expression of the plural, unless it has a clearly different meaning in the context. The terms, “include,” “comprise,” “is configured to,” etc. of the description are used to indicate the presence of features, numbers, steps, operations, elements, parts, or combinations thereof, and do not exclude the possibilities of combination or addition of one or more features, numbers, steps, operations, elements, parts, or combination thereof.

Unless otherwise indicated, terms used herein, including technical or scientific terms, may mean the same as that which would be commonly understood by a person of ordinary skill in the art to which the present disclosure belongs. Terms defined in commonly used dictionaries can be interpreted as having meanings consistent with the context of the relevant technology.

In example embodiments, a vehicle can refer to various vehicles moving a transported object such as a person, an animal, or an object from a starting point to a destination. Such vehicles are not limited to vehicles running on roads or tracks. Also, vehicles may include vehicles using fossil fuels such as gasoline and petrol, as well as vehicles using secondary batteries using electricity stored in batteries, and vehicles using future fuels such as hydrogen.

In the description below, the terms “front,” “rear,” “side,” “back,” “upper,” “upper,” “lower,” “bottom,” “left and right,” or the like, used in relation to direction can be with respect to the vehicle or vehicle body.

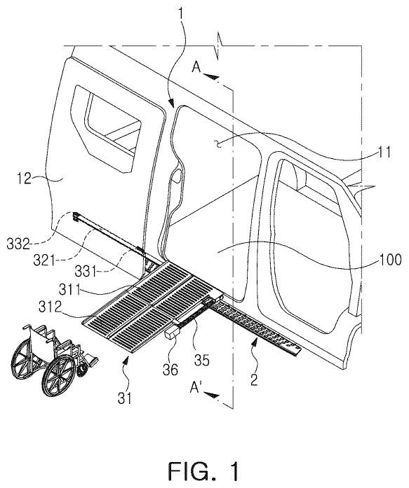

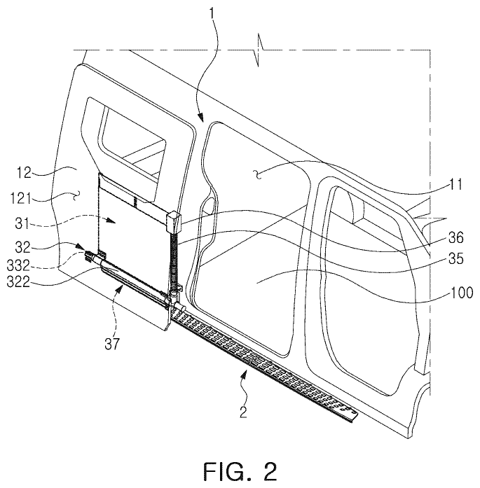

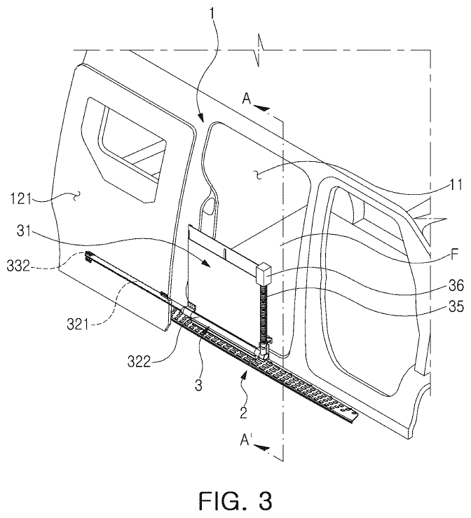

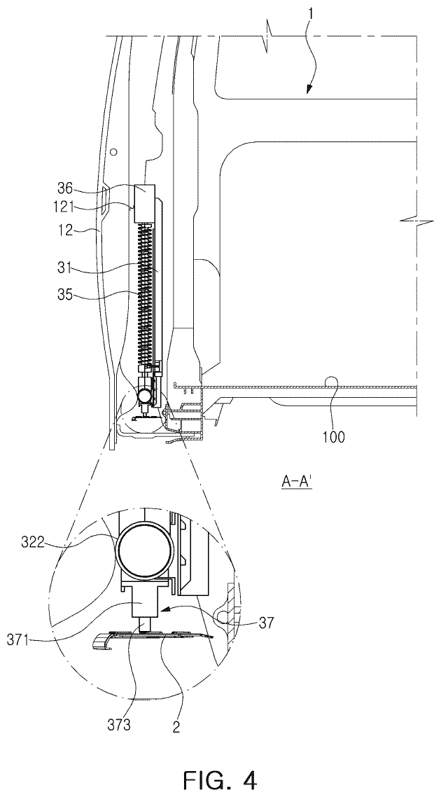

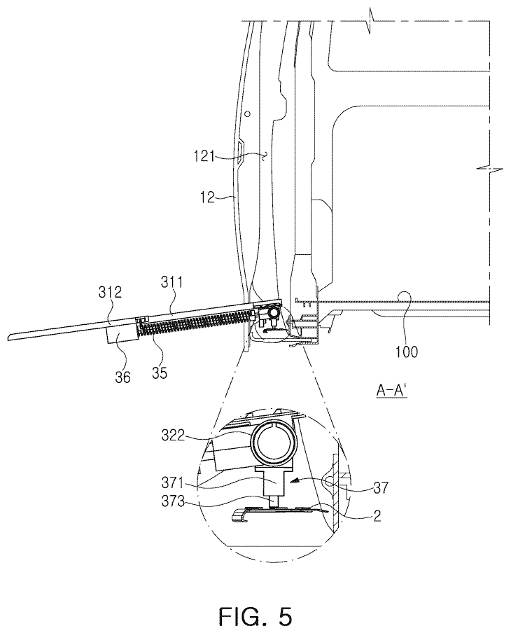

FIG. 1 is a diagram illustrating a usage state in which a ramp is unfolded according to an embodiment. FIG. 2 is a diagram illustrating a state in which a ramp is inserted into a door of a vehicle body according to an embodiment. FIG. 3 is a diagram illustrating a state in which a ramp is withdrawn from a door of a vehicle body according to an embodiment. FIG. 4 is a diagram illustrating the state in FIG. 3 taken along line A-A′ in FIG. 3. FIG. 5 is a diagram illustrating the state in FIG. 1 taken along line A-A′ in FIG. 1.

Referring to FIGS. 1 to 5, a ramp system according to an embodiment will be described.

An opening 11 may be disposed in a vehicle body 1. A passenger may board or alight through the opening 11. Also, cargo may board or alight the vehicle through the opening 11.

A door 12 may be provided in a vehicle body 1. The door 12 may be configured as a sliding door. That is, the door 12 may open and close the opening 11 while moving along a side surface of the vehicle body 1. The internal space 121 of the door 12 may be disposed with respect to the state in which the door 12 is open. A ramp plate 31 may be disposed in the space 121. The ramp plate 31 may be inserted into the internal space 121 of the door 12 or withdrawn from the space 121.

A side step 2 may be disposed on a lower side of the vehicle body 1. The side step 2 may be a way for assisting a process of boarding or alighting a passenger. Specifically, when a passenger attempts to board the vehicle body 1 through the opening 11 of the vehicle body 1, the passenger may step onto the side step 2 and may board through the opening 11. Conversely, when a passenger attempts to alight out of the vehicle body 1 through the opening 11 of the vehicle body 1, the passenger may step on the side step 2 and may alight through the opening 11.

The side step 2 may be configured as a rod structure. An upper surface of the side step 2 may include a flat surface. A projection or a groove may be disposed on the upper surface of the side step 2. The side step 2 may be coupled to the vehicle body 1. The side step 2 may move by being coupled to the vehicle body 1. The side step 2 may move up and down. Specifically, the side step 2 may be elevated from a lower side of vehicle body 1 to an upper side of the vehicle body. With respect to the state in which the side step 2 is elevated, the upper surface of the side step 2 may preferably be disposed on a lower side than the opening 11. Because the side step 2 may be elevated to assist boarding and alighting of passengers, a maximum elevation height of the side step 2 may be configured to be lower than the opening 11 preferably.

Referring to FIG. 2, when the door 12 is opened, the ramp plate 31 may move together with the door 12. That is, the frame 32 may be coupled to the door 12, and the ramp plate 31 may be coupled to the frame 32. The frame 32 and the ramp plate 31 may move together by movement of the door 12, and the opening 11 may be completely opened.

Referring to FIGS. 3 and 4, the side step 2 may move up and down, and the ramp plate 31 may be withdrawn from an internal space 121 of the door 12. In the process of withdrawing the ramp plate 31, the side step 2 may support the withdrawn ramp plate 31. Specifically, the side step 2 may support a support portion 37, which will be described below. The support portion 37 may be coupled to a moving frame 322, and the ramp plate 31 may be withdrawn by movement of a moving frame 322. The side step 2 may support the support portion 37 and may guide movement of the support portion 37 according to movement of the moving frame 322.

Referring to FIGS. 1, 5, and 6, after the ramp plate 31 is withdrawn from the internal space 121 of the door 12, the ramp brackets 341, 342 connecting the ramp plate 31 to the frame 32 may rotate, such that the ramp plate 31 may also rotate. The ramp plate 31 may rotate toward the outer side of the vehicle body 1. The ramp plate 31 may include a base plate 311 and a sliding plate 312. After the ramp plate 31 rotates, the sliding plate 312 may move relative to the base plate 311, such that a length of the ramp plate 31 may extend and a slope may also be formed. The slope of the ramp plate 31 may become a path connecting the exterior of the vehicle body 1 to the opening 11 of the vehicle body 1.

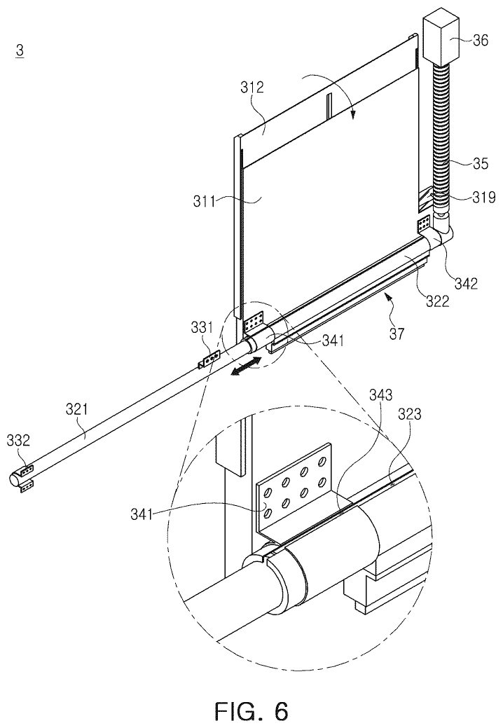

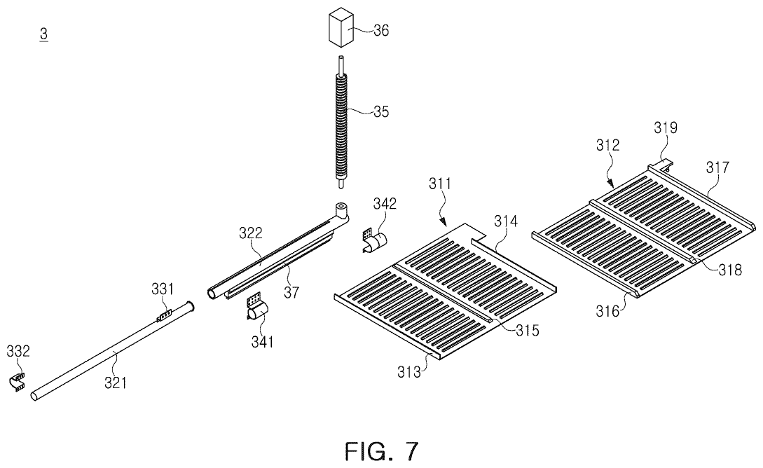

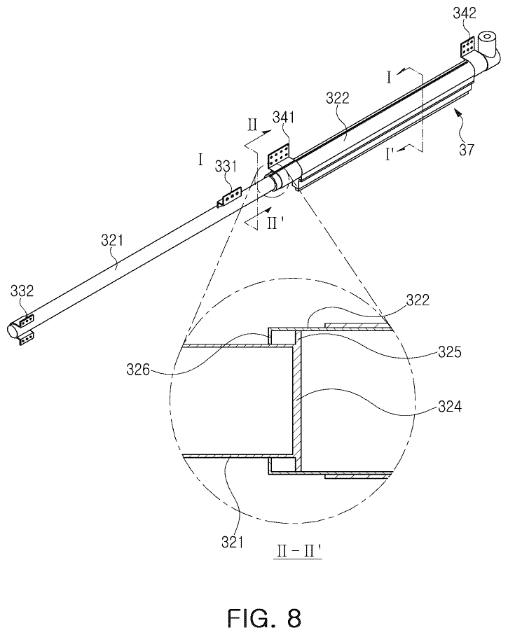

FIG. 6 is a perspective diagram illustrating a ramp assembly according to an embodiment. FIG. 7 is an exploded diagram illustrating a ramp assembly according to an embodiment. FIG. 8 is a perspective diagram illustrating a portion of a ramp assembly according to an embodiment. The structure of the ramp assembly 3 according to an embodiment may be described further with reference to FIGS. 6 to 8.

A ramp assembly 3 may include a frame 32, fixed brackets 331, 332, ramp brackets 341, 342, a ramp plate 31, a screw 35, a driving portion 36 and a support portion 37.

The frame 32 may include a fixed frame 321 and a moving frame 322. The fixed frame 321 may be configured as a rod structure having a length. A cross-section of the fixed frame 321 may be circular. The fixed frame 321 may have a cylindrical structure having a void interior such that a weight may be reduced.

The fixed frame 321 may be coupled to an internal side of door 12 by fixed brackets 331, 332. The fixed brackets 331, 332 may be disposed on the fixed frame 321. The fixed brackets 331, 332 may be disposed on an outer circumferential surface of the fixed frame 321. The fixed brackets may include a first fixed bracket 331 and a second fixed bracket 332. The first fixed bracket 331 may be disposed to be close to one side of the fixed frame 321. The second fixed bracket 332 may be disposed to be close to another side of the fixed frame 321. The first fixed bracket 331 and the second fixed bracket 332 may be spaced apart from each other in the length direction of the fixed frame 321.

The fixed brackets 331, 332 may be coupled to the door 12. The fixed brackets 331, 332 may be coupled to a structure such as a bracket separately provided to the door 12. That is, the fixed brackets 331, 332 may be coupled to the door 12 and may connect the fixed frame 321 to the door 12.

The moving frame 322 may be disposed to be close to the outer side of the fixed frame 321. The moving frame 322 may be disposed to surround at least a portion of an outer circumferential surface of the fixed frame 321. The moving frame 322 may have a cylindrical structure having a void internal side. The fixed frame 321 may be disposed on an internal side of the moving frame 322. The moving frame 322 may be coupled to the fixed frame 321 and may be configured to move along the length direction of the fixed frame 321. That is, as the moving frame 322 moves along the length direction of the fixed frame 321, the length of the frame 32 may change, and the position of the ramp plate 31 may also change.

A guide groove 323 may be disposed on the external surface of the moving frame 322. The guide groove 323 may be formed in the length direction of the moving frame 322. The guide groove 323 may be configured to cut a portion of the moving frame 322 along the length direction of the moving frame 322. The guide groove 323 may overlap the first fixed bracket 331 in the length direction of the fixed frame 321. In some cases, the fixed brackets 331, 332 may be disposed in the guide groove 323. With respect to FIG. 6, the first fixed bracket 331 may be disposed in the guide groove 323. Specifically, when the moving frame 322 moves in the length direction of the fixed frame 321 and the overall length of the frame 32 decreases, the first fixed bracket 331 may be positioned in the guide groove 323. The first fixed bracket 331 and the guide groove 323 may guide the moving frame 322 to move along the length direction of the fixed frame 321.

Ramp brackets 341, 342 may be disposed on the outer side of the moving frame 322. The ramp brackets may include a first ramp bracket 341 and a second ramp bracket 342.

The first ramp bracket 341 may be disposed to be close to one side of the moving frame 322. The second ramp bracket 342 may be disposed to be close to the other side of the moving frame 322.

The first ramp bracket 341 may be disposed along an outer circumferential surface of the moving frame 322. That is, an inner circumferential surface of the first ramp bracket 341 may correspond to the outer circumferential surface of the moving frame 322. The first ramp bracket 341 may include a cutout portion 343. The cutout portion 343 may be formed in a direction corresponding to the length direction of the moving frame. The first ramp bracket 341 may rotate along the outer circumferential surface of the moving frame. Accordingly, the cutout portion 343 may be disposed to directly face the guide groove 323 of the moving frame 322 in the radial direction of the moving frame 322.

Referring to the enlarged view in FIG. 8, the structure of the fixed frame and the moving frame will be described in greater detail.

One side end of the fixed frame 321 may be disposed on the internal side of the moving frame 322. One side end of the fixed frame 321 disposed on the internal side of the moving frame 322 may be referred to as an end portion 324.

A flange portion 325 may be disposed on the end portion 324. A diameter of the end portion 324, measured including the flange portion 325, may be formed to be greater than a diameter of the fixed frame 321. The end portion 324 may be disposed on the internal side of the moving frame 322, and because the moving frame 322 may be configured to move along the length direction of the fixed frame 321, the diameter of the end portion 324, measured including the flange portion 325, may be formed to be smaller than the inner diameter of the moving frame 322.

A step portion 326 having a ring shape may be disposed on one side end of the moving frame 322. The inner diameter of the step portion 326 may be formed smaller than the inner diameter of the moving frame 322. However, the inner diameter of the step portion 326 may be formed greater than the diameter of the fixed frame 321. The step portion 326 of the moving frame 322 may face the flange portion 325 of the fixed frame 321. When the moving frame 322 moves in the length direction of the fixed frame 321 such that the entire length of the frame 32 increases, movement of the moving frame 322 may be limited by the flange portion 325 and the step portion 326. That is, the position in which the flange portion 325 and the step portion 326 are in contact with each other as the moving frame may be the movement limit position of the moving frame 322.

The ramp plate 31 may be disposed to rotate in the frame 32. The ramp plate 31 may be disposed to rotate with the moving frame 322 as a rotation axis. The ramp plate 31 may be coupled to the first ramp bracket 341 and the second ramp bracket 342, and the first ramp bracket 341 and the second ramp bracket 342 may rotate with respect to the moving frame 322, such that the ramp plate 31 may rotate with the moving frame 322 as a rotation axis.

The ramp plate 31 may include a flat plate structure having a flat surface. One side of a lower surface of the ramp plate 31 may be coupled to the ramp brackets 341, 342. The ramp plate 31 may include a base plate 311 and a sliding plate 312. One surface of the base plate 311 and one surface of the sliding plate 312 may be disposed to face each other. The sliding plate 312 may be disposed to face the base plate 311 and may be configured to move. The length of the ramp plate 31 may be changed by movement of the sliding plate 312.

A guide portion may be disposed in the base plate 311. The guide portion may be a rod shape extending almost parallel to the sliding direction of the sliding plate 312.

A plurality of the guide portion may be disposed. The plurality of guide portions may include a first guide portion 313 disposed on one side of the base plate 311, a second guide portion 314 disposed on the other side of the base plate 311, and a third guide portion 315 disposed between the first guide portion 313 and the second guide portion 314. The first guide portion 313, the second guide portion 314, and the third guide portion 315 may be spaced apart from each other and may be disposed parallel to each other.

The first guide portion 313, the second guide portion 314, and the third guide portion 315 may be provided as separate members and may be coupled to an upper surface of the base plate 311. Alternatively, in the first guide portion 313, the second guide portion 314 and the third guide portion 315, a portion of the base plate 311 may be bent and integral with the base plate 311. The first guide portion 313, the second guide portion 314 and the third guide portion may reinforce rigidity of the base plate 311. The first guide portion 313 and the second guide portion 314 may be disposed on one side and the other side of the base plate 311, respectively, such that a wheelchair, or the like, moving on the ramp plate 31 may be prevented from deviating to the outer side of the ramp plate 31.

A plurality of grooves or projections may be disposed on the surface of the base plate 311. A portion of the plurality of grooves or projections may be disposed between the first guide portion 313 and the third guide portion 315, and the other portion of the plurality of grooves or projections may be disposed between the second guide portion 314 and the third guide portion 315. The length direction of each of the plurality of grooves or projections may be a direction intersecting the length direction of the first guide portion 313. The plurality of grooves or projections may increase frictional force for a wheelchair, or the like, moving on the base plate 311.

A guide portion may be disposed on the sliding plate 312. The guide portion disposed on the sliding plate 312 may have a structure corresponding to the guide portion of the base plate 311. That is, when viewed from the upper surface of the sliding plate 312, the guide portion of the sliding plate 312 may have a protruding structure, and when viewed from the lower surface of the sliding plate 312, the guide portion of the sliding plate 312 may have a concave groove structure. That is, the guide portion of the base plate 311 may be disposed in the concave groove structure of the sliding plate 312.

A plurality of the guide portion of the sliding plate 312 may be disposed. The plurality of guide portions may include a fourth guide portion 316 disposed on one side of the sliding plate 312, a fifth guide portion 317 disposed on the other side of the sliding plate 312, and a sixth guide portion 318 disposed between the fourth guide portion 316 and the fifth guide portion 317. The fourth guide portion 316, the fifth guide portion 317, and the sixth guide portion 318 may be spaced apart from each other and may be disposed in parallel with each other.

The fourth guide portion 316, the fifth guide portion, and the sixth guide portion 318 may reinforce rigidity of the sliding plate 312. Because the fourth guide portion 316 and the fifth guide portion 317 are disposed on one side and the other side of the sliding plate, respectively, a wheelchair, or the like, moving on the sliding plate 312 may be prevented from deviating from the outer side of the sliding plate 312.

A plurality of grooves or projections may be disposed on the surface of the sliding plate 312. A portion of the plurality of grooves or projections may be disposed between the fourth guide portion 316 and the sixth guide portion 318, and the other portion of the plurality of grooves or projections may be disposed between the fifth guide portion 317 and the sixth guide portion 318. The length direction of each of the plurality of grooves or projections may be a direction intersecting the length direction of the fourth guide portion 316. The plurality of grooves may increase frictional force for a wheelchair, or the like, moving on the sliding plate 312.

A screw bracket 319 may be disposed in a side portion of the sliding plate 312. The screw bracket 319 may be mechanically coupled to the screw 35 described below. The screw bracket 319 may be provided to engage with a thread on a surface of the screw 35. Accordingly, the screw bracket 319 may move along the length direction of the screw 35 according to the rotation of the screw 35, and the sliding plate 312 may also move along the length direction of the screw bracket 319.

A driving portion 36 may be disposed on one end of the screw 35. The driving portion 36 may include a motor. The driving portion 36 may be configured as a device rotating the screw 35. The other end of the screw 35 may be coupled to the frame 32. Specifically, the other end of the screw 35 may be coupled to a moving frame 322 and may rotate. A thread may be disposed on an outer circumferential surface of the screw 35. Accordingly, when the screw 35 rotates by the driving portion 36, the screw bracket 319 engaged with the screw 35 may move the sliding plate 312 along the length direction of the screw 35.

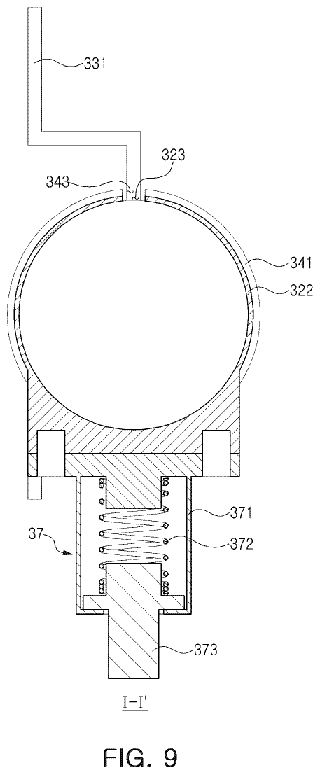

FIG. 9 is a cross-sectional diagram taken along line I-I′ in FIG. 8. The support portion will be described with reference to FIGS. 8 and 9.

The support portion 37 may be coupled to the moving frame 322. The support portion 37 may be disposed between the first ramp bracket 341 and the second ramp bracket 342. The lower side of the support portion 37 may face the side step 2, and the upper side of the support portion 37 may be disposed to face the moving frame 322. When the ramp plate 31 is unfolded, the support portion 37 may be disposed between the ramp plate 31 and the side step 2 and may support the ramp plate 31 in a direction perpendicular to the ground.

The support portion 37 may include a housing 371, a spring 372, and a support stand 373. The housing 371 may form the overall exterior of the support portion. The housing 371 may have a structure similar to a box having a void interior. The upper side of the housing 371 may be coupled to the moving frame 322, and the lower side of the housing 371 may be open.

A spring 372 may be disposed on the internal side of the housing 371. A plurality of the spring 372 may be disposed. The plurality of springs 372 may be spaced apart from each other along the length direction of the housing 371.

A portion of the support stand 373 may be disposed internally of the housing. The other portion of the support stand 373 may be disposed externally of the housing 371. Specifically, the upper side of the support stand 373 may be disposed internally of the housing 371 by being in contact with the spring 372. The lower side of the support stand 373 may be protruded into the lower side of the housing 371. The lower side of the support stand 373 may be in contact with the upper surface of the side step 2, and a plurality of springs 372 disposed on an upper side of the support stand 373 may reduce impacts between the housing 371 and the support stand.

Referring again to FIGS. 1 to 3, operations of a ramp system in an embodiment will be described.

The door 12 may be opened by sliding. Because the ramp plate 31 can be inserted into the internal space 121 of the door 12, the ramp plate 31 may move together with the door 12. When the door 12 is opened, the opening 11 of the vehicle body 1 may be exposed.

Thereafter, the ramp plate 31 may be withdrawn. The ramp plate 31 may be withdrawn to cover a portion of the opening 11 of the vehicle body 1. When the ramp plate 31 is withdrawn, the side step 2 may be elevated, and the upper surface of the side step 2 and the support stand 373 of the support portion 37 may face each other. The withdrawing of the ramp plate 31 and elevation of the side step 2 may also be performed in the opposite order.

Thereafter, the ramp plate 31 may rotate to expose the ramp plate 31 to the outer side of the vehicle body, and when the ramp plate 31 is exposed to the outer side of the vehicle body, the driving portion 36 may rotate the screw 35, may slide the sliding plate 312 with respect to the base plate 311 and may complete unfolding of the ramp plate 31.

A passenger may pass the ramp plate 31 and may board the vehicle body 1 through the opening 11.

According to an embodiment, the ramp assembly 3 may form a slope connecting the exterior and the interior of the vehicle body 1, thereby facilitating boarding or alighting of transportation-disadvantaged passengers. Also, because the support portion 37 of the ramp assembly 3 is supported by the side step 2 disposed on the lower portion of the outer side of the vehicle body, the height of the ramp plate 31 from the ground may be relatively lowered with respect to the vehicle body 1, which may be advantageous. That is, because the position of the ramp plate 31 from the ground may be lowered with respect to the vehicle body 1 side, the slope angle of the ramp plate 31 may decrease. Also, because the position of the ramp plate 31 from the ground may be lower or equal to the position of the vehicle body bottom 100 from the ground with respect to the vehicle body 1 side, the slope angle of the ramp may be reduced.

According to the aforementioned embodiments, a ramp system may widen the space in the interior of the vehicle body by mounting the ramp on the door, and by decreasing the slope angle of the ramp, boarding of transportation-disadvantaged passengers may be easily performed. Also, wheelchairs, or the like, may be prevented from falling off the ramp and injuries to transportation-disadvantaged passengers may be prevented.

A number of embodiments have been disclosed herein. It is understood that various features of the different embodiments can be combined. While the example embodiments have been illustrated and described above, it can be apparent to those skilled in the art that modifications and variations could be manufactured without departing from the scopes of the present disclosure as defined by the appended claims.

What is claimed is:

1. A ramp system, comprising:
a frame; and
a ramp plate configured to move along a first length direction of the frame, wherein the ramp plate includes a base plate that is rotatable with the frame as a rotation axis.

2. The system of claim 1, further comprising a sliding plate disposed to face a first surface of the base plate and configured to move along the first surface of the base plate.

3. The system of claim 2, further comprising:
a screw disposed on one side of the base plate; and
a screw bracket coupled to the sliding plate, coupled to the screw, configured to move along a second length direction of the screw.

4. The system of claim 3, further comprising a driving portion disposed on a first end of the screw and configured to rotate the screw.

5. The system of claim 4, wherein a second end of the screw is disposed in the frame.

6. The system of claim 2, wherein the frame comprises:
a fixed frame configured to be coupled to a vehicle door; and
a moving frame disposed on an outer side of the fixed frame and configured to slide along the fixed frame, wherein the base plate is coupled to the moving frame.

7. The system of claim 6, further comprising a fixed bracket coupled to the fixed frame and configured to connect the fixed frame to a door.

8. The system of claim 7, wherein the fixed bracket comprises:
a first fixed bracket disposed on a first fixed-frame side of the fixed frame;
and a second fixed bracket spaced apart from the first fixed bracket in the first length direction of the fixed frame.

9. The system of claim 8, wherein the moving frame includes a guide groove extending in the first length direction of the moving frame, and
wherein the guide groove overlaps the first fixed bracket in the first length direction of the moving frame.

10. The system of claim 6, wherein a ramp bracket is disposed on an outer circumferential surface of the moving frame, and
wherein the ramp bracket is coupled to the base plate.

11. The system of claim 10, wherein the ramp bracket is configured to rotate along the outer circumferential surface of the moving frame.

12. The system of claim 6, wherein the moving frame includes a support portion configured to support a load of the ramp plate.

13. The system of claim 12, wherein the support portion comprises:
a housing;
a spring disposed on an internal side of the housing; and
a support stand having at least a portion protruding from an outer side of the housing.

14. A vehicle, comprising:
a vehicle body having an opening;
a door disposed on the vehicle body, wherein the door is configured to open and close the opening of the vehicle body;
a ramp plate disposed in an internal space of the door; and
a frame coupled to the door and configured to allow the ramp plate to slide relative to the door,
wherein the ramp plate comprises:
a base plate configured to rotate with the frame as a rotation axis, and
a sliding plate disposed to face a first surface of the base plate and configured to slide along the first surface of the base plate.

15. The vehicle of claim 14, further comprising:
a side step disposed on a lower portion of the vehicle body; and
a support portion coupled to the frame, wherein the side step is configured to support a lower side of the support portion.

16. The vehicle of claim 15, wherein the support portion comprises:
a housing;
a support stand having at least a portion protruding from an outer side of the housing; and
a spring disposed on an internal side of the housing, wherein the spring is configured to support the support stand, and wherein the support stand is configured to make contact with the side step.

17. A vehicle comprising:
a vehicle body having an opening;
a door slidably coupled to the vehicle body, wherein the door is configured to cover and uncover the opening of the vehicle body;
a side step coupled to the vehicle body adjacent the opening, wherein the side step is at least partially below the opening;
a ramp system coupled to the door, wherein the ramp system comprises:
a fixed frame fixedly attached to the door,
a movable frame slidable coupled to the fixed frame, and
a ramp rotatably coupled to the movable frame,
wherein the ramp system is configured to have a first configuration with the movable frame and the ramp positioned adjacent to the door while the door covers the opening,
wherein the ramp system is configured to have a second configuration with the movable frame and the ramp positioned adjacent to the door while the door uncovers the opening,
wherein the ramp system is configured to have a third configuration with the movable frame positioned adjacent the opening, with the movable frame positioned adjacent the side step, and with the ramp positioned to partially cover the opening while the door uncovers the opening, and
wherein the ramp system is configured to have a fourth configuration with the movable frame positioned adjacent the opening, with the movable frame positioned on the side step, with the ramp adjacent the opening, and with the ramp extending at a slope away from the opening toward a ground surface, while the door uncovers the opening.

18. The vehicle of claim 17, wherein the side step is configured to move relative to the vehicle body.

19. The vehicle of claim 17, wherein the ramp comprises:
a first ramp plate rotatably coupled to the movable frame and configured to rotate about the movable frame; and
a second ramp plate slidably coupled to the first ramp plate and configured to extend an overall length of the ramp based on the second ramp plate sliding relative to the first ramp plate.

20. The vehicle of claim 19, further comprising support portion on the movable frame, wherein the support portion comprises:
a housing;
a spring disposed in the housing; and
a support stand having a first support-stand portion in the housing and contacting the spring, and a second support-stand portion protruding from the housing, wherein the second support-stand portion is configured to make contact with the side step, wherein the side step is configured to support the movable frame via the support portion, and wherein the spring is configured to bias the support stand toward the side step.
